(19) United States
(12) Patent Application Publication
(10) Pub. No.: US 2025/0175919 A1
(43) Pub. Date: May 29, 2025

(54) SYSTEMS AND METHODS FOR GLOBAL NAVIGATION SATELLITE SYSTEM-LESS OPERATION MODES FOR NON-TERRESTRIAL NETWORKS

(71) Applicant: APPLE INC., Cupertino, CA (US)

(72) Inventors: Chunxuan Ye, San Diego, CA (US); Dawei Zhang, Saratoga, CA (US); Wei Zeng, Saratoga, CA (US); Hong He, San Jose, CA (US); Chunhai Yao, Beijing (CN); Fangli Xu, Beijing (CN); Haijing Hu, Los Gatos, CA (US); Yuqin Chen, Beijing (CN)

(21) Appl. No.: 18/921,186

(22) Filed: Oct. 21, 2024

Related U.S. Application Data
(60) Provisional application No. 63/603,443, filed on Nov. 28, 2023.

(51) Int. Cl. H04W 56/00; H04B 7/185

(52) U.S. Cl. CPC H04W 56/003; H04W 56/0045; H04B 7/185

(57) ABSTRACT

Systems and methods for global navigation satellite system (GNSS)-less operation modes for non-terrestrial networks (NTNs) are disclosed. A user equipment (UE) of an NTN identifies a GNSS data acquisition failure; sends, to a base station, a request to transition from operating in a first timing advance (TA) mode where the UE determines a first TA value using GNSS data to operating in a second TA mode where the UE determines a second TA value without using any GNSS data; receives, from the base station, a reply indicating that the UE may transition to operating in the second TA mode; performs the transition; determines a timing of an uplink (UL) transmission using a correspondingly calculated second TA value; and sends the UL transmission per the timing. Analogous base station behaviors are discussed. In some cases, a UE determines to make the transition based on factors other than GNSS (e.g., power saving).

### CROSS-REFERENCE TO RELATED APPLICATION(S)

This application claims the benefit of U.S. Provisional Patent Application No. 63/603,443, filed Nov. 28, 2023, which is hereby incorporated by reference herein in its entirety.

### TECHNICAL FIELD

This application relates generally to wireless communication systems, including wireless communications systems using non-terrestrial network (NTN) communications.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an NTN architecture of a wireless communication system, according to an embodiment.

FIG. 2 illustrates an NTN architecture of a wireless communication system, according to an embodiment.

FIG. 3 illustrates a timeline corresponding to the use of a GNSS-less operation mode for a UE that communicates with a base station over a service link of an NTN network, according to embodiments discussed herein.

FIG. 4 illustrates a procedure performed by a UE for entering and exiting a closed loop TA mode, according to embodiments herein.

FIG. 5 illustrates a method of a UE of an NTN, according to embodiments discussed herein.

FIG. 6 illustrates a method of a base station of an NTN, according to embodiments discussed herein.

FIG. 7 illustrates a method of a UE of an NTN, according to embodiments discussed herein.

FIG. 8 illustrates an example architecture of a wireless communication system, according to embodiments disclosed herein.

FIG. 9 illustrates a system for performing signaling between a wireless device and a RAN device connected to a core network of a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### Embodiments of Non-Terrestrial Networks (NTNs)

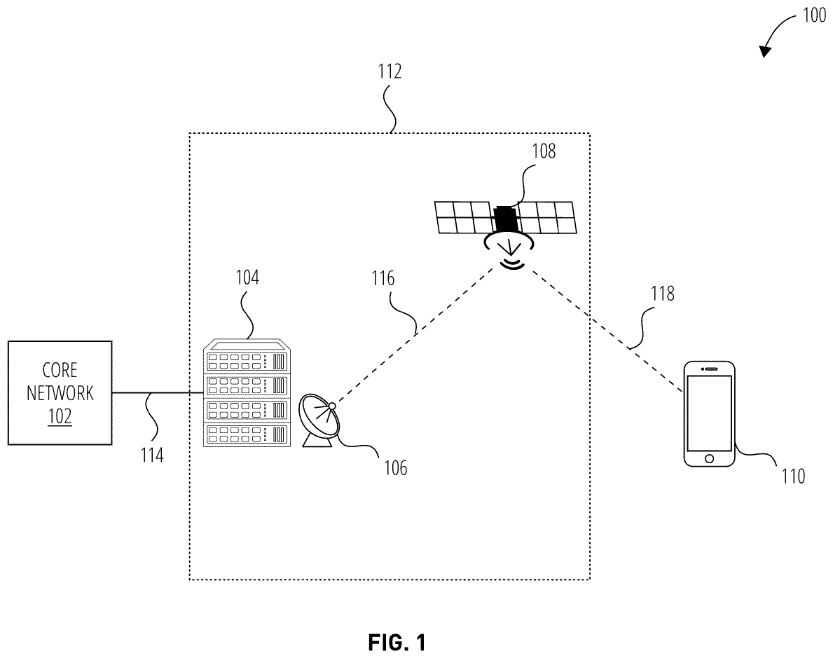

FIG. 1 illustrates an NTN architecture 100 of a wireless communication system, according to an embodiment. The NTN architecture 100 includes a core network (CN) 102, a terrestrial base station 104, a satellite gateway 106, a satellite 108, and a UE 110. The terrestrial base station 104, the satellite gateway 106, and the satellite 108 may be included in a RAN 112.

In some embodiments, the RAN 112 includes E-UTRAN, the CN 102 includes an EPC, and the terrestrial base station 104 includes an eNB. In these cases, the CN link 114 connecting the CN 102 and the terrestrial base station 104 may include an S1 interface.

In some embodiments, RAN 112 includes NG-RAN, the CN 102 includes a 5GC, and the terrestrial base station 104 includes a gNB or a next generation eNB (ng-eNB). In such cases, the CN link 114 connecting the CN 102 and the terrestrial base station 104 may include an NG interface.

The NTN architecture 100 illustrates a “bent-pipe” or “transparent” satellite based architecture. In such bent-pipe systems, the terrestrial base station 104 uses the satellite gateway 106 to communicate with the satellite 108 over a feeder link 116. The satellite 108 may be equipped with one or more antennas capable of broadcasting a cell according to the RAN 112, and the UE 110 may be equipped with one or more antennas (e.g., a moving parabolic antenna, an omni-directional phased-array antenna, etc.) capable of communicating with the satellite 108 via a Uu interface on that cell (such communications may be said to use the illustrated service link 118). A payload sited on the satellite 108 then transparently forwards data between the satellite gateway 106 and the UE 110 using the feeder link 116 between the satellite gateway 106 and the satellite 108 and the service link 118 between the satellite 108 and the UE 110. The payload may perform radio frequency (RF) conversion and/or amplification in both uplink (UL) and downlink (DL) to enable this communication.

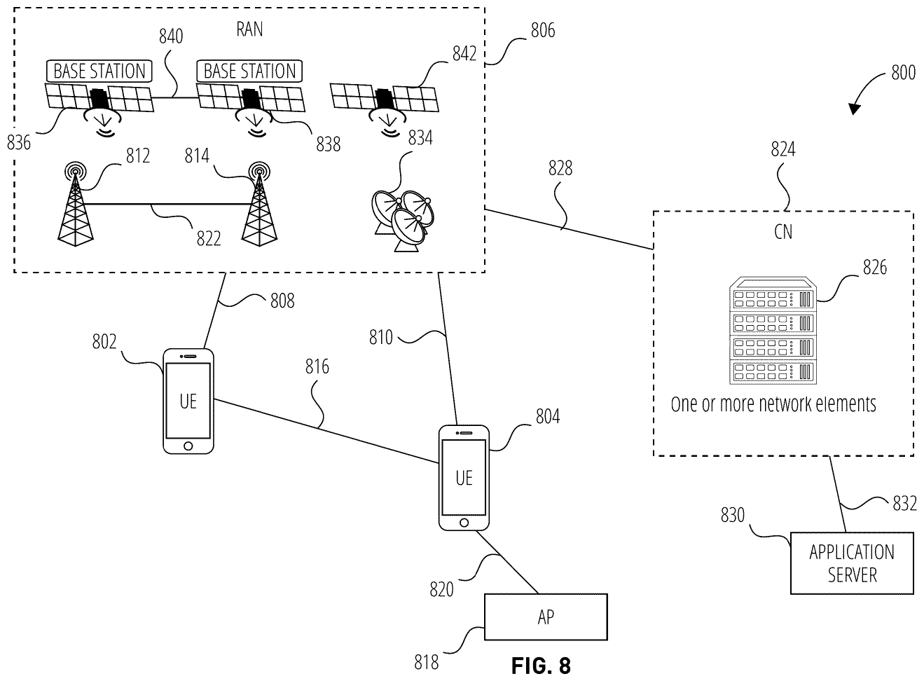

In the embodiment shown in FIG. 1, the terrestrial base station 104 is illustrated without the capability of terrestrial wireless communication directly with a UE. However, it is contemplated that in other embodiments, such a terrestrial base station using the satellite gateway 106 to communicate with the satellite 108 could (also) have this functionality (i.e., as in the terrestrial base station 812 and the terrestrial base station 814 of FIG. 8, to be described below).

It may be understood that, in alternative embodiments to FIG. 1, the satellite 108 may instead be a non-satellite NTN vehicle (e.g., an airplane, an unmanned aerial vehicle (UAV), an unmanned aircraft system (UAS), an airship, a balloon, etc.). Further, it may be understood in such alternative embodiments that the satellite gateway 106 may instead be a gateway for or corresponding to the applicable NTN vehicle type.

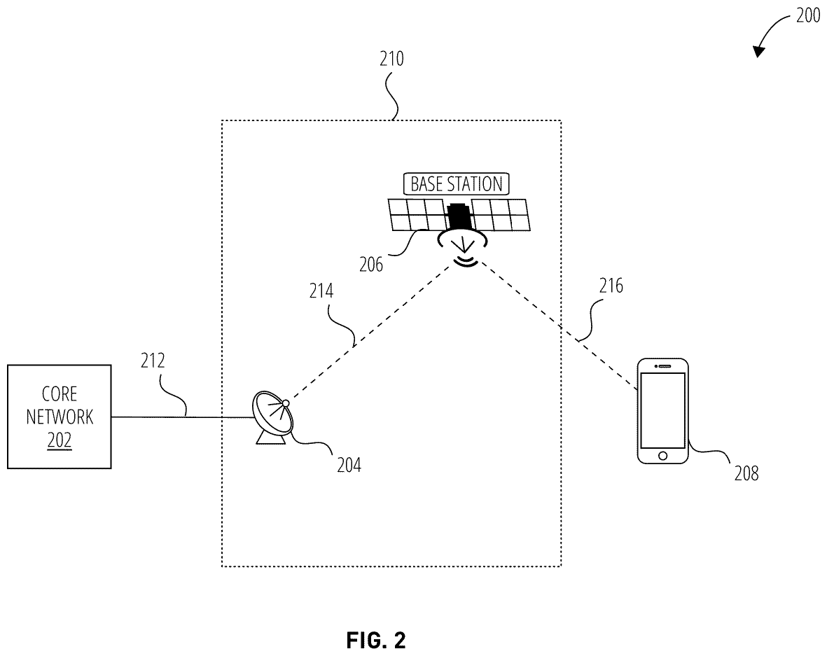

FIG. 2 illustrates an NTN architecture 200 of a wireless communication system, according to an embodiment. The NTN architecture 200 includes a CN 202, a satellite gateway 204, a satellite base station 206, and a UE 208. The satellite gateway 204 and the satellite base station 206 may be included in the RAN 210.

In some embodiments, the RAN 210 includes E-UTRAN and the CN 202 includes an EPC. In these cases, the CN link 212 connecting the CN 202 and the satellite gateway 204 may include an S1 interface.

In some embodiments, RAN 210 includes NG-RAN and the CN 202 includes a 5GC. In such cases, the CN link 212 connecting the CN 202 and the satellite gateway 204 may include an NG interface.

The NTN architecture 100 implements a “regenerative” satellite-based architecture. In such regenerative systems, the functionalities of a base station are sited on the satellite base station 206, and the communications between these base station functions and the CN 202 occur through a forwarding of interface(s) (e.g., a S1 interface and/or an NG interface) found on the CN link 212 through the satellite gateway 204 and a feeder link 214 to the satellite base station 206. The satellite base station 206 may be equipped with one or more antennas capable of broadcasting a cell according to the RAN 210, and the UE 208 may be equipped with one or more antennas (e.g., a moving parabolic antenna, an omni-directional phased-array antenna, etc.) capable of communicating with the satellite base station 206 via a Uu interface on that cell (such communications may be said to use the illustrated service link 216). A payload sited on the satellite base station 206 then forwards data between the satellite gateway 204 and the UE 208 using the feeder link 214 between the satellite gateway 204 and the satellite base station 206 and the service link 216 between the satellite base station 206 and the UE 208. The payload may perform RF conversion and/or amplification in both uplink (UL) and downlink (DL) to enable this communication, as well as implement the functionalities of the base station (e.g., as an eNB, ng-eNB or a gNB, as corresponding to the type of the RAN 210) as these have been sited on the satellite base station 206.

In embodiments of NTN architectures comprising NG-RAN that also use integrated access and backhaul (IAB), it is possible that a gNB control unit functionality (CU) could be sited terrestrially and may use a satellite gateway to communicate with a satellite that hosts a corresponding gNB donor unit functionality (DU), with the F1 interface(s) between the CU and the DU underpinned by the feeder link 214. In such cases, the CU and the DU may each be understood to be part of the NG-RAN.

It may be understood that, in alternative embodiments to FIG. 2, the satellite base station 206 may instead be a non-satellite NTN base station (e.g., an airplane, a UAV, a UAS, an airship, a balloon, etc.). Further, it may be understood in such alternative embodiments that the satellite gateway 204 may instead be a gateway for or corresponding to the applicable NTN vehicle type. Accordingly, with respect to disclosure herein, embodiments that refer to a “satellite” should be understood to be examples within this larger context (e.g., it should be understood that analogous embodiments using a non-satellite NTN vehicle could also be developed according to the principles discussed in those embodiments).

### Embodiments of Uplink (UL) Time and Frequency Synchronization

In some wireless communication systems, a timing advance (TA) value applied by an NR NTN UE in various radio resource control (RRC) states (e.g., RRC_IDLE, RRC_INACTIVE and RRC_CONNECTED) is given by:

$${T}_{TA} = ( {N}_{TA} + {N}_{TA , UE - specific} + {N}_{TA , common} + {N}_{TA , offset} ) \times {T}_{C} ,$$

where:
T_{TA} is the TA value;

N_{TA} is 0 for a physical random access channel (PRACH) procedure and is from there updated based on a TA command field in a message 2 (Msg2) and/or a message B (MsgB) of PRACH and/or in a medium access control (MAC) control element (MAC-CE) TA command (note that specific details with respect to the updating and/or accumulation of N_{TA} may follow various possibilities);
N_{TA,UE-specific} is a UE self-estimated value for TA to pre-compensate for the service link delay;
N_{TA,common} is a network-controlled common value for TA, and may include any timing offset considered appropriate by the network (note that an N_{TA,common} with value of 0 may be supported, and that various cases for particular signaling specifics (e.g., including granularity) may be considered);
N_{TA,offset} is a fixed offset; and
T_{C} is a basic time unit for the RAT.

It may be noted that an applicable N_{TA} may be permitted to vary across different embodiments. In some embodiments, a UE might not assume that a round trip time (RTT) between the UE and the base station is equal to the calculated TA for a message 1 (Msg1) and/or message A (MsgA) of a PRACH. Further, in some embodiments, N_{TA,common} is understood as common timing offset.

It is contemplated that an NTN UE may be global navigation satellite system (GNSS) capable (meaning that is has the capability to receive GNSS signaling and determine a location of the UE with the GNSS signaling). In some wireless communication systems, an NTN UE in an RRC_IDLE state or an RRC_INACTIVE state may be configured to support the generation and use of a UE-specific TA calculation that is based at least in part on a GNSS-acquired position of the NTN UE (along with other related information, such as, for example, a serving satellite ephemeris). With respect to such cases, an NR NTN UE in an RRC_IDLE state or an RRC_INACTIVE state may use its acquired GNSS position and satellite ephemeris information to calculate a frequency pre-compensation to counter shift/account for the Doppler effect as experienced on the service link between the UE and the satellite.

An NR NTN UE in an RRC_CONNECTED state can also use its acquired GNSS position and satellite ephemeris to perform frequency pre-compensation to counter shift/account for the Doppler experienced on the service link. Additionally, an NTN UE in an RRC_CONNECTED state may be configured to support a UE-specific TA calculation based at least on its GNSS-acquired position and the serving satellite ephemeris.

In some embodiments of cases of sporadic short transmissions, an NTN UE in an RRC_CONNECTED state can go back to idle mode and re-acquire a GNSS position fix if/when GNSS position information at the UE becomes outdated.

An NTN UE can autonomously determine its GNSS validity duration (e.g., in X seconds and/or minutes) and report information associated with this validity duration to the network via RRC signaling. Across various cases, X may be 10 seconds, 20 seconds, 30 seconds, 40 seconds, 50 seconds, 60 seconds, 5 minutes, 10 minutes, 15 minutes, 20 minutes, 25 minutes, 30 minutes, 60 minutes, 90 minutes, 120 minutes, and/or infinity.

### Embodiments of GNSS Operations

With respect to various wireless communication systems (e.g., NR NTN), the implementation of enhanced GNSS operations has been considered. Such enhanced GNSS operation may relate to RRC_CONNECTED state operation robustness for the case of an NTN UE with GNSS capability and corresponding to cases of GNSS outage at the NTN UE. Such GNSS outages may occur at the NTN UE due to, for example, a UE location (e.g., the UE is at a location where it cannot receive GNSS signaling). Such GNSS outages may be understood to occur over a duration of time during which the NTN UE does not receive the GNSS signaling. Note that across different embodiments, a time length of the period of the GNSS outage for which the enhanced GNSS operations described herein are used may vary.

It is noted that to facilitate discussion, an “NTN UE” may be referred to herein more simply as a UE.

Further, herein, a “closed loop TA mode” may refer to cases where information that is received from the base station is used by the UE to determine a TA value, and in which GNSS information determined at the UE is not used by the UE to calculate a TA.

Still further, an “open and closed loop TA mode” may refer to cases where GNSS information determined at the UE (independently of the RAN/base station) may be used by the UE in conjunction with “closed loop”-type information to calculate a TA value. Accordingly, it may be understood that the GNSS information determined at the UE is an example of an “open loop” type of information.

Within the context of current wireless communication systems using NTN UEs that can use GNSS operations that depend on such open loop GNSS information, there may be no additional mechanism for supporting a (fully) closed loop TA mode (e.g., for cases when the expected GNSS information is not available at/to the UE). With respect to subsequent disclosure, note that a “closed loop mode” refers to cases that do not use a GNSS information open loop component, and accordingly are not using an “open and closed loop TA mode.”

Each of the open TA mode and the open and closed TA modes may be examples of “TA modes” as discussed herein.

Embodiments disclosed herein discuss systems, methods, and implementations for closed loop TA modes. Such contexts may leverage an enhanced TA command that includes one or more aspects such as: an enlarged TA range, a TA drifting rate, and/or a TA drifting rate's higher order derivative(s). Further, in some cases, a closed loop TA mode may include a frequency offset command.

Embodiments disclosed herein also discuss a procedure/mechanism for causing an NTN UE to enter and/or exit the closed loop TA mode. For example, such procedures/mechanisms may include the use of closed loop TA mode triggering condition(s) and corresponding signaling defined according to various details, including signaling contents and singling containers.

### Embodiments of GNSS-Less Operation Modes for NTNs

In some embodiments, a closed loop TA mode for use in NTN contexts may be introduced. In this state, closed loop information is used to adjust an uplink transmission TA, and no GNSS-based and/or ephemeris-based open loop TA information affects the calculation.

Consider the generalized formula for a TA value T_{TA}:

$${T}_{TA} = ( {N}_{TA} + {N}_{TA , UE - specific} + {N}_{TA , common} + {N}_{TA , offset} ) \times {T}_{C} .$$

In cases of closed loop TA control mode, it may be that N_{TA}, UE-specific, the UE self-estimated value to pre-compensate for the service link delay (e.g., which may be based at least in part on GNSS information), may be considered an “open loop component” of T_{TA} (the finally calculated TA value for use at the UE) and therefore is not used (i.e., is set to 0) in the TA calculation formula in the closed loop TA mode. Further, it may be optional whether or not to use N_{TA,common} in the TA calculation formula in the closed loop TA mode.

When considering the TA calculation formula in the closed loop TA mode (e.g., where GNSS information is not available/used by the UE), it may be that control of the T_{TA} depends on a calculation of N_{TA} (which is an ultimately network-controlled value) such that enhanced TA control is provided for this context. Note that N_{TA} may be considered a “closed loop component” of T_{TA} (the finally calculated TA for use at the UE).

In first embodiments for calculating an N_{TA} under a closed loop TA mode, it may be that a MAC-CE is communicated from the network/base station to the UE. This MAC-CE may provide a TA drift rate (D_{TA-drift}) to the UE that may be used by the UE. In some cases, the MAC-CE may additionally include a second derivative (D_{TA-driftvariant}) and/or further higher order derivatives of the TA drift. An epoch time (t_{epoch}) of the MAC-CE TA command may also be provided in the MAC-CE.

Then, T_{TA} is calculated through the use of a new N_{TA} value (N_{TA,new}) in the TA calculation formula, where:

$${N}_{TA , new} ( t ) = {N}_{TA , old} + {D}_{TA - drift} * ( t - {t}_{epoch} ) + {D}_{TA - driftvariant} * {( t - {t}_{epoch} )}^{2} ,$$

where N_{TA,old} is a prior N_{TA} value (a prior closed loop component) previously used to determine a prior T_{TA} value.

In second embodiments for calculating an N_{TA} under a closed loop TA mode, a new MAC-CE with an enlarged and/or modified TA command (TAC) range corresponding to a TAC field may be introduced.

In some such embodiments, bits of a TAC field in a MAC-CE may have a modified granularity and/or step (e.g., as compared to TAC fields used in prior wireless communication systems). It may be in such contexts that, for example a new N_{TA} value (N_{TA,new}) for use in the TA calculation formula is calculated using:

$${N}_{TA - new} = {N}_{TA - old} + ( {T}_{A} - 31 ) * S * 16 * 64 / {2}^{μ} ,$$

N_{TA-new} is the new N_{TA} value;
N_{TA-old} is a prior N_{TA} value (a prior closed loop component) previously used to determine a prior T_{TA} value;
TA is a TAC value found in the TAC field of the MAC-CE (e.g., in the range (0, . . . , 63));
S is a scaling factor; and
μ is a subcarrier spacing (SCS) value corresponding to an SCS used for the UL transmission.

In such cases, the scaling factor S used in this arrangement represents the modification to the granularity and/or step of bits of the TAC field as discussed. The scaling factor S may be configured to the UE in a system information block (SIB) or in dedicated RRC signaling.

In other such embodiments, rather than modifying a granularity and/or step of the TA command MAC-CE, the TAC field of the MAC-CE is instead allocated with a larger number of bits such that it can represent a larger value range as compared to prior wireless communication systems. It may be in such contexts that, for example, a new N_{TA} value (N_{TA,new}) for use in the TA calculation formula is calculated using:

$${N}_{TA - new} = {N}_{TA - old} + ( {T}_{A} - 31 ) * 16 * 64 / {2}^{μ} ,$$

N_{TA-new} is the new N_{TA} value;
N_{TA-old} is a prior N_{TA} value (a prior closed loop component) previously used to determine a prior T_{TA} value;
TA is a TAC value found in the TAC field of the MAC-CE (e.g., in the range (0, . . . , 255));
μ is a subcarrier spacing (SCS) value corresponding to an SCS used for the UL transmission.

In such cases, the possible range/number of representations possible by the TAC value TA allows N_{TA} (N_{TA-new}) to take a wider range of values than in prior wireless communication systems.

In other such embodiments, it may be that both a modified granularity/step and a larger allocation of bits in a TAC field of the MAC-CE may be used. It may be in such contexts that, for example, a new N_{TA} value (N_{TA,new}) for use in the TA calculation formula is calculated using:

$${N}_{TA - new} = {N}_{TA - old} + ( {T}_{A} - 31 ) * S * 16 * 64 / {2}^{μ} ,$$

where
N_{TA-new} is the new N_{TA} value;
N_{TA-old} is a prior N_{TA} value (a prior closed loop component) previously used to determine a prior T_{TA} value;
TA is a TAC value found in the TAC field of the MAC-CE (e.g., in the range (0, . . . , 255));
S is a scaling factor; and
μ is a subcarrier spacing (SCS) value corresponding to an SCS used for the UL transmission.

Note that in some such cases, a scaling factor of S=1 is possible/allowable.

In third embodiments for calculating an N_{TA} under a closed loop TA mode, it may be that a TA command is signaled in downlink control information (DCI). For example, either an uplink grant DCI or a downlink grant DCI may be used.

In some cases of such embodiments, the DCI may contain a TAC field having a TAC value TA for use at the UE, which is used to determine a new N_{TA} value (N_{TA,new}) using:

$${N}_{TA - new} = {N}_{TA - old} + ( {T}_{A} - 31 ) * 16 * 64 / {2}^{μ} ,$$

where
N_{TA-new} is the new N_{TA} value;
N_{TA-old} is a prior N_{TA} value (a prior closed loop component) previously used to determine a prior T_{TA} value;
TA is the TAC value in the TAC field of the DCI; and
μ is a subcarrier spacing (SCS) value corresponding to an SCS used for the UL transmission.

In other cases of such embodiments, the DCI may use an (e.g., already existing) field (other than a new TAC field) to provide the TAC value TA to the UE. For example, the DCI may use the most significant bit (MSB) bits of a modulation and coding scheme (MCS) field of the DCI to communication the TAC value T_{A}. Then, the UE may use that TAC value TA to calculate a new N_{TA} (N_{TA,new}) using N_{TA-new}=N_{TA-old}+(T_{A}−31)*16*64/2^{μ} (e.g., as just discussed).

In embodiments that communicate a TA command/a TAC value TA using DCI, the activation time for the TA command may also be included in the DCI. This activation time may represent, for example, a value of time (e.g., X milliseconds) after the reception of the DCI (where X, for example, could be less than 3 milliseconds).

Note that cases where a DCI includes other kinds of information are contemplated useful for calculating a new N_{TA} are contemplated. For example, it may be possible to communicate a TA drift rate (D_{TA-drift}) a second derivative (D_{TA-driftvariant}) and/or further higher order derivatives of the TA drift, and/or an applicable epoch time (t_{epoch}) in a DCI (e.g., analogously as is discussed above in relation to a MAC-CE case). In such cases, the new N_{TA} (N_{TA,new}) value for the TA calculation formula may be determined according to, for example, N_{TA,new}=N_{TA,old}+D_{TA-drift}*(t−t_{epoch})+D_{TA-driftvariant}*(t−t_{epoch})².

In some embodiments disclosed herein, communications used in a closed loop TA mode may include information with respect to frequency offset control. For example, in some cases, a frequency offset drift rate (including second order or higher order drift derivatives) may be provided.

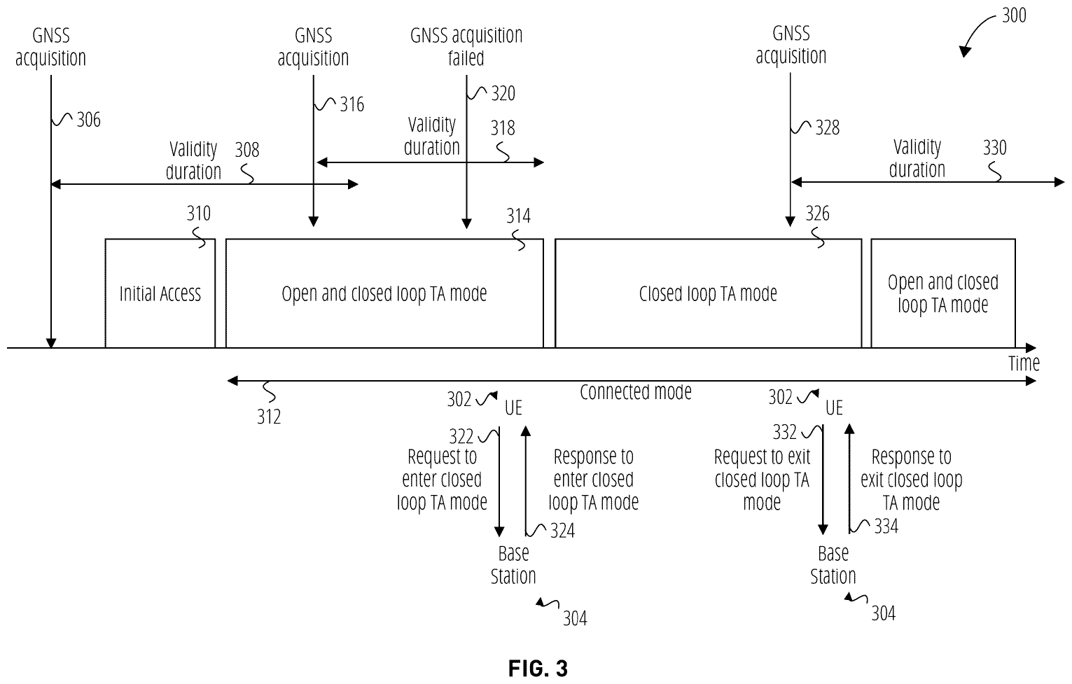

FIG. 3 illustrates a timeline 300 corresponding to the use of a GNSS-less operation mode for a UE 302 that communicates with a base station 304 over a service link of an NTN network, according to embodiments discussed herein. The timeline 300 illustrates that the UE performs a first GNSS acquisition 306 and determines its present location. The UE understands this location information to be valid (e.g., useable/applicable) at the UE for the illustrated first validity duration 308.

The UE 302 then performs initial access 310 to the network/the base station 304 and subsequently enters the connected mode 312 with the network/the base station 304. While in the connected mode 312, the UE 302 first operates according to the open and closed loop TA mode 314, during which it uses location information as determined corresponding to the first GNSS acquisition 306 to drive an open loop component N_{TA}, UE-specific that is used (among other values) to calculate a T_{TA} during all or part of the first validity duration 308 of the first GNSS acquisition 306.

Further, after the illustrated second GNSS acquisition 316, the UE may use corresponding (e.g., updated) location information to drive N_{TA,UE-specific} during a second validity duration 318 for the second GNSS acquisition 316, as shown.

The UE 302 then undergoes a GNSS acquisition failure 320, due to, for example, a failure to receive GNSS signaling and/or a failure to receive GNSS signaling of an acceptable level of quality/that meets requirements. In response, the UE 302 sends the base station 304 a first request 322 to enter a closed loop TA mode (in which GNSS-derived location information is not used to calculate a T_{TA}). In response, the base station 304 sends the UE 302 a first reply 324 indicating that the UE may enter the closed loop TA mode. As illustrated, the first request 322 and the first reply 324 may be sent within the second validity duration 318 of the second GNSS acquisition 316 and therefore while the UE is still in the open and closed loop TA mode 314.

After the expiration of the open and closed loop TA mode 314 and/or after the expiration of the second validity duration 318, the UE 302 enters the closed loop TA mode 326, in which GNSS-derived location information is not used to calculate a T_{TA} (rather, the system relies on an enhanced mechanism for generating a closed loop component N_{TA} to calculate an acceptable T_{TA}, using one or more such mechanisms as described herein).

While in the closed loop TA mode 326, the UE 302 performs a third GNSS acquisition 328 in which GNSS signaling is received (e.g., at an acceptable quality level/per a requirement), thus enabling the UE to determine its own location. As illustrated, the third GNSS acquisition 328 corresponds to a third validity duration 330.

With valid GNSS-derived location data again available at the UE 302, the UE accordingly sends the base station 304 a second request 332 to (re) enter the open and closed loop TA mode (in which GNSS-derived location information is used to calculate a T_{TA}). In response, the base station 304 sends the UE 302 a second reply 334 indicating that the UE may (re) enter the open and closed loop TA mode. As illustrated, the second request 332 and the second reply 334 may be sent after the third GNSS acquisition 328 and prior to the UE (re) entering the open and closed loop TA mode 314.

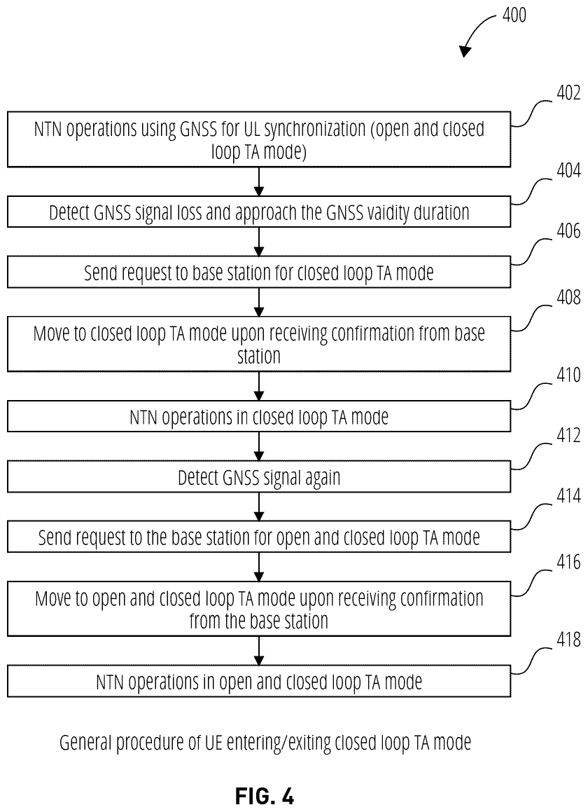

FIG. 4 illustrates a procedure 400 performed by a UE for entering and exiting a closed loop TA mode, according to embodiments herein. The UE may first perform 402 NTN operations using GNSS information for UL synchronization (e.g., may calculate a T_{TA} according to an open and closed loop TA mode that uses GNSS-derived location information).

The UE may then detect 404 that a GNSS signal loss has occurred and that it is approaching the end of a GNSS validity duration of GNSS information that is currently in use.

The UE may then send 406 a request to the base station to enter into a closed loop TA mode.

Upon receiving confirmation of the closed loop TA mode from the base station, the UE may move 408 to the closed loop TA mode.

The UE may accordingly perform 410 NTN operations without using GNSS information for UL synchronization (e.g., may calculate a T_{TA} according to a closed loop TA mode that does not use GNSS-derived location information).

Then, the UE may detect 412 a GNSS signal (e.g., of appropriate quality/meeting a requirement) such that GNSS-based location information is again established/determinable at the UE.

The UE may send 414 a request to the base station to (re) enter the open and closed loop TA mode.

Upon receiving confirmation of the open and closed loop TA mode from the base station, the UE may move 416 to the open and closed loop TA mode.

Finally, the UE may perform 418 NTN operations using GNSS information for UL synchronization (e.g., may calculate a T_{TA} according to the open and closed loop TA mode that uses GNSS-derived location information).

### Embodiments of UE Requests to Enter a Closed Loop TA Mode

In some embodiments, one or more of various possible triggering conditions for a UE request to enter the closed loop TA mode to be sent may apply. In one example, a triggering condition may be based on if the UE loses/is unable to receive GNSS signaling.

Another triggering condition for a UE to request to enter the closed loop TA mode may be that received GNSS signaling does not satisfy certain quality level/other requirement.

Another triggering condition for a UE to request to enter the closed loop TA mode may be that a time for expiry of a validity duration for current GNSS information is approaching/is within a certain time duration threshold (e.g., that a remaining portion of a validity duration for current GNSS-derived location data at the UE does not meet the threshold).

With respect to such cases, an applicable threshold for this time of expiration for current GNSS data may depend on, for example, a round trip time between the UE and the base station.

Alternatively, an applicable threshold with respect to this time of expiration may vary/depend on the applicable scenario/categorization for the satellite. For example, a relatively lower threshold may be used in the case that the UE is communicating with a low earth orbit (LEO) satellite, a relatively medium threshold may be used in the case that the UE is communicating with a geostationary earth orbit (GEO) satellite, and/or a relatively larger threshold may be used in the case that the UE is communicating with a medium earth orbit (MEO) satellite.

Alternatively, an applicable threshold with respect to this time of expiration may be based on a timing drift rate (e.g., a downlink (DL) timing drift rate). In such cases, it may be that a relatively higher timing drift rate results in a relatively smaller threshold being used.

Another triggering condition for a UE to request to enter the closed loop TA mode may be based on a determination (e.g., at the UE) that the UE is capable supporting/using the closed loop TA mode.

In some cases, a triggering condition for a UE to request to enter the closed loop TA mode may be based on a UE determination that it has limited power/that the UE wants to save power by avoiding receiving a GNSS signal. Note that mechanisms discussed herein triggered by the loss of (sufficient) GNSS signaling may be considered usable in response to the case where, as here, a GNSS signal is electively not being used by the UE. In other words, it may be understood that for example, the GNSS acquisition failure 320 of FIG. 3 and/or the detecting 404 the GNSS signal loss of FIG. 4 could be functionally replaced by a determination by the UE to enter a power saving mode and correspondingly send a request to enter the closed loop TA mode, corresponding to the election by the UE not to use a GNSS signal.

A request to enter the closed loop TA mode may include one or more of: a GNSS expiry timing, or the time when UE moves to an RRC_IDLE state if no response is received to the request (the value may be up to UE implementation); an (explicit) request to enter the closed loop TA mode; current timing information at the UE; a last measured GNSS location and/or GNSS measurement time at the UE; and/or a GNSS position fix duration (a desired minimum duration of the closed loop TA mode).

The request to enter the closed loop TA mode may be sent in, for example, any of MAC-CE signaling, RRC signaling, and/or uplink control information (UCI).

### Embodiments of Base Station Replies to UE Requests to Enter a Closed Loop TA Mode

In some embodiments, a response by a base station to a request from a UE to enter the closed loop TA mode may include one or more of: a timing for the action of entering the closed loop TA mode; a TAC field having a TAC value (a T_{A}) (including, e.g., a TAC field that uses a modified granularity/step and/or a larger allocation of bits, as described elsewhere herein); frequency offset information; and/or a maximum possible duration for operating in the closed loop TA mode (which implicitly indicates that UE is to move to, for example, an RRC_IDLE state and/or an RRC_INACTIVE state after operating in the closed loop TA mode for this duration).

The reply to the request to enter the closed loop TA mode may be sent in, for example, any of MAC-CE signaling, RRC signaling, and/or DCI.

In some cases, if the reply is not received before an expiry of an applicable validity duration of GNSS information currently in use, the UE moves to an RRC_IDLE state and/or an RRC_INACTIVE state. In other cases, if the reply is not received before the expiry of the validity duration of the GNSS information currently in use, the UE may receive an RRC release comprising an RRC connection failure from the base station with the message cause of “GNSS signal loss.”

### Embodiments of UE Requests to Exit a Closed Loop TA Mode

In some examples, a triggering condition for a UE to request to exit a closed loop TA mode (e.g., to (re) enter an open and closed loop TA mode) may be that the UE (re) acquires GNSS signaling that satisfies certain quality requirements.

A request to exit the closed loop TA mode may include a validity duration for a new GNSS position fix.

The request to exit the closed loop TA mode may be sent in, for example, any of MAC-CE signaling, RRC signaling, and/or UCI.

### Embodiments of Base Station Replies to UE Requests to Exit a Closed Loop TA Mode

In some embodiments, a response by a base station to a request by a UE to exit a closed loop TA mode may include a timing for the action of exiting the closed loop TA mode.

The reply to the request to exit the closed loop TA mode may be sent in, for example, any of MAC-CE signaling, RRC signaling, and/or DCI.

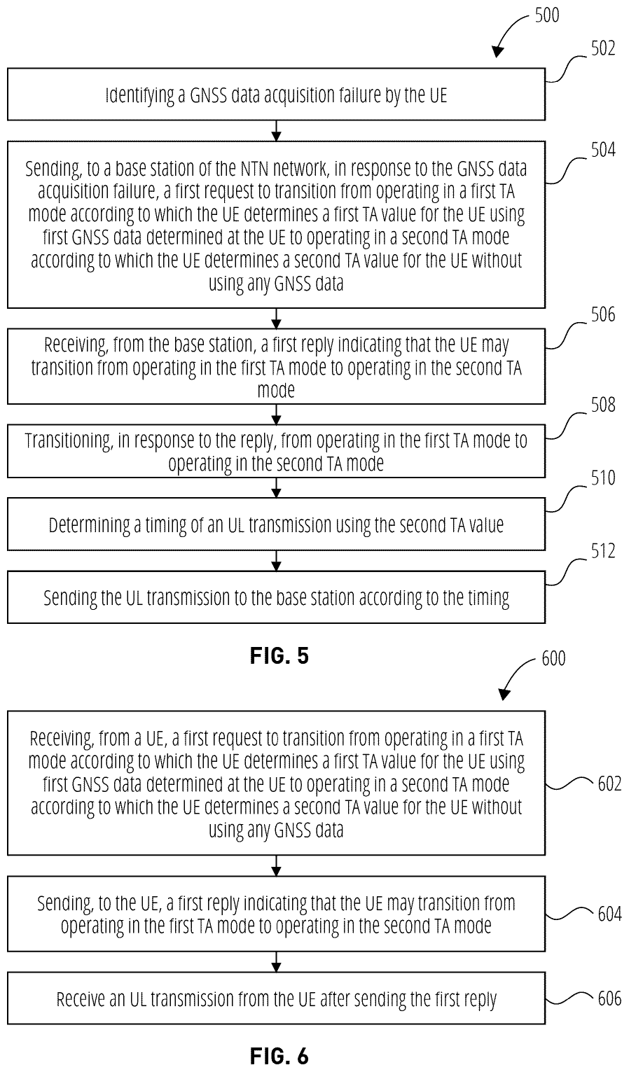

FIG. 5 illustrates method 500 of a UE of an NTN, according to embodiments discussed herein. The method 500 includes identifying 502 a GNSS data acquisition failure by the UE. The method 500 further includes sending 504, to a base station of the NTN network, in response to the GNSS data acquisition failure, a first request to transition from operating in a first TA mode according to which the UE determines a first TA value for the UE using first GNSS data determined at the UE to operating in a second TA mode according to which the UE determines a second TA value for the UE without using any GNSS data. The method 500 further includes receiving 506, from the base station, a first reply indicating that the UE may transition from operating in the first TA mode to operating in the second TA mode. The method 500 further includes transitioning 508, in response to the reply, from operating in the first TA mode to operating in the second TA mode. The method 500 further includes determining 510, method 500 determines a timing of an UL transmission using the second TA value. The method 500 further includes sending 512 the UL transmission to the base station according to the timing.

In some embodiments, to determine the second TA value according to the second TA mode, the method 500 further includes: receiving, from the base station, a MAC-CE comprising a TA drift rate of a TA drift, a higher order derivative for the TA drift, and an epoch time; and calculating a closed loop component of the second TA value [1] using the TA drift rate, the higher order derivative of the TA drift, and the epoch time.

In some embodiments, to determine the second TA value according to the second TA mode, the method 500 further includes: receiving, from the base station, a MAC-CE having a TAC field of greater than six bits; and calculating a closed loop component of the second TA value using a TAC value represented in the TAC field.

In some embodiments, to determine the second TA value according to the second TA mode, the method 500 further comprises: receiving a MAC-CE comprising a TAC value; and calculating a closed loop component of the second TA value using:

$${N}_{TA - new} = {N}_{TA - old} + ( {T}_{A} - 31 ) * S * 16 * 64 / {2}^{μ} ,$$

where:
N_{TA-new} is the closed loop component of the second TA value; N_{TA-old} is a prior closed loop component for the first TA value; TA is the TAC value; S is a scaling factor; and u is a subcarrier spacing (SCS) value corresponding to an SCS used for the UL transmission.

In some embodiments, to determine the second TA value according to the second TA mode, the method 500 further includes: receiving, from the base station, a DCI comprising a TAC field; and calculating a closed loop component of the second TA value using a TAC value represented in the TAC field.

In some embodiments, to determine the second TA value according to the second TA mode, the method 500 further includes: receiving, from the base station, a DCI comprising a TAC value in an MCS field of the DCI; and calculating a closed loop component of the second TA value using the TAC value.

In some embodiments, to determine the second TA value according to the second TA mode, the method 500 further includes: receiving, from the base station, a DCI comprising a TA drift rate for a TA drift, a higher order derivative of the TA drift, and an epoch time; and calculating a closed loop component of the second TA value using the TA drift rate, the higher order derivative of the TA drift, and the epoch time.

In some embodiments of the method 500, the GNSS data acquisition failure comprises a loss of a GNSS signal at the UE.

In some embodiments of the method 500, the GNSS data acquisition failure comprises a determination at the UE that a received GNSS signal does not meet a GNSS signal requirement.

In some embodiments of the method 500, the first request is sent in further response to a determination that a remaining portion of a GNSS data validity duration for the first GNSS data at the UE does not meet a threshold. In some such embodiments, the threshold depends on one or more of: an RTT between the UE and the base station; a distance between the UE and an NTN vehicle for an NTN service link used by the UE to communicate with the base station; and a timing drift rate at the UE.

In some embodiments of the method 500, the first request comprises one or more of: an expiration time of a GNSS data validity duration for the first GNSS data; a last GNSS-measured location by the UE; and a desired minimum duration for operating in the second TA mode.

In some embodiments of the method 500, the first reply comprises one or more of: a timing for the transitioning from the first TA mode to the second TA mode; a TAC value; and a maximum duration for operating in the second TA mode.

In some embodiments, the method 500 further includes: identifying, after entering the second TA mode, a successful GNSS data acquisition of second GNSS data at the UE; sending, to the base station, in response to the successful GNSS data acquisition of the second GNSS data, a second request to transition from operating in the second TA mode to operating in the first TA mode according to which the UE determines a third TA value for the UE using the second GNSS data; receiving, from the base station, a second reply indicating that the UE may transition from operating in the second TA mode to operating in the first TA mode; and transitioning, in response to the second reply, from operating in the second TA mode to operating the first TA mode. In some such embodiments, the second request comprises a GNSS data validity duration for the second GNSS data. In some such embodiments, the second reply comprises a timing for the transitioning from the second TA mode to the first TA mode.

In some embodiments of the method 500, the first TA mode is an open and closed loop TA mode.

In some embodiments of the method 500, the second TA mode is a closed loop TA mode.

FIG. 6 illustrates a method 600 of a base station of an NTN, according to embodiments discussed herein. The method 600 includes receiving 602, from a UE, a first request to transition from operating in a first TA mode according to which the UE determines a first TA value for the UE using first GNSS data determined at the UE to operating in a second TA mode according to which the UE determines a second TA value for the UE without using any GNSS data. The method 600 further includes sending 604, to the UE, a first reply indicating that the UE may transition from operating in the first TA mode to operating in the second TA mode. The method 600 further includes receiving 606 receives an UL transmission from the UE after sending the first reply.

In some embodiments, the method 600 further includes sending, to the UE, a MAC-CE comprising a TA drift rate of a TA drift, a higher order derivative of the TA drift, and an epoch time.

In some embodiments, the method 600 further includes sending, to the UE, a MAC-CE) having a TAC field of greater than six bits.

In some embodiments, the method 600 further includes sending, to the UE, a MAC-CE comprising a TAC value configured to be used to calculate a closed loop component of the second TA value at the UE using:

$${N}_{TA - new} = {N}_{TA - old} + ( {T}_{A} - 31 ) * S * 16 * 64 / {2}^{μ} ,$$

where:
N_{TA-new} is the closed loop component of the second TA value; N_{TA-old} is a prior closed loop component for the first TA value; TA is the TAC value; S is a scaling factor; and u is a subcarrier spacing (SCS) value corresponding to an SCS used for the UL transmission.

In some embodiments, the method 600 further includes sending, to the UE, a DCI comprising a TAC field.

In some embodiments, the method 600 further includes sending, to the UE, a DCI comprising a TAC value in an MCS field of the DCI.

In some embodiments, the method 600 further includes sending, to the UE, a DCI comprising a TA drift rate for a TA drift, a higher order derivative of the TA drift, and an epoch time.

In some embodiments of the method 600, the first request comprises one or more of: an expiration time of a GNSS data validity duration for the first GNSS data; a last GNSS-measured location by the UE; and a desired minimum duration for operating in the second TA mode.

In some embodiments of the method 600, the first reply comprises one or more of: a timing for a transitioning from the first TA mode to the second TA mode; a TAC value; and a maximum duration for operating in the second TA mode.

In some embodiments, the method 600 further includes receiving, from the UE, a second request to transition from operating the second TA mode to operating in the first TA mode according to which the UE determines a third TA value for the UE using second GNSS data; and sending, to the UE, a second reply indicating that the UE may transition from operating in the second TA mode to operating in the first TA mode. In some such embodiments, the second request comprises a GNSS data validity duration for the second GNSS data.

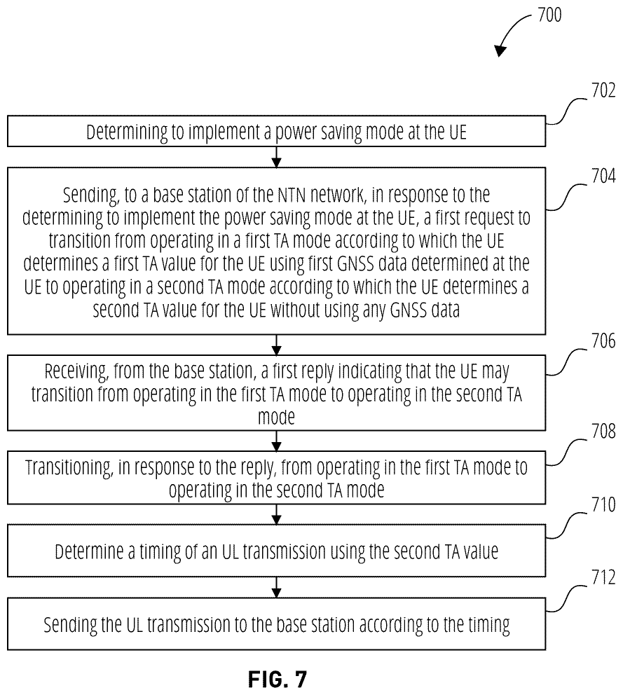

FIG. 7 illustrates a method 700 of a UE of an NTN, according to embodiments discussed herein. The method 700 includes determining 702 to implement a power saving mode at the UE. The method 700 further includes sending 704, to a base station of the NTN network, in response to the determining to implement the power saving mode at the UE, a first request to transition from operating in a first TA mode according to which the UE determines a first TA value for the UE using first GNSS data determined at the UE to operating in a second TA mode according to which the UE determines a second TA value for the UE without using any GNSS data. The method 700 further includes receiving 706, from the base station, a first reply indicating that the UE may transition from operating in the first TA mode to operating in the second TA mode. The method 700 further includes transitioning 708, in response to the reply, from operating in the first TA mode to operating in the second TA mode. The method 700 further includes determining 710 a timing of an UL transmission using the second TA value. The method 700 further includes sending 712 the UL transmission to the base station according to the timing.

In some embodiments, to determine the second TA value according to the second TA mode, the method 700 further includes: receiving, from the base station, a MAC-CE comprising a TA drift rate of a TA drift, a higher order derivative for the TA drift, and an epoch time; and calculating a closed loop component of the second TA value [1] using the TA drift rate, the higher order derivative of the TA drift, and the epoch time.

In some embodiments, to determine the second TA value according to the second TA mode, the method 700 further includes: receiving, from the base station, a MAC-CE having a TAC field of greater than six bits; and calculating a closed loop component of the second TA value using a TAC value represented in the TAC field.

In some embodiments, to determine the second TA value according to the second TA mode, the method 700 further comprises: receiving a MAC-CE comprising a TAC value; and calculating a closed loop component of the second TA value using:

$${N}_{TA - new} = {N}_{TA - old} + ( {T}_{A} - 31 ) * S * 16 * 64 / {2}^{μ} ,$$

where:
N_{TA-new} is the closed loop component of the second TA value; N_{TA-old} is a prior closed loop component for the first TA value; TA is the TAC value; S is a scaling factor; and u is a subcarrier spacing (SCS) value corresponding to an SCS used for the UL transmission.

In some embodiments, to determine the second TA value according to the second TA mode, the method 700 further includes: receiving, from the base station, a DCI comprising a TAC field; and calculating a closed loop component of the second TA value using a TAC value represented in the TAC field.

In some embodiments, to determine the second TA value according to the second TA mode, the method 700 further includes: receiving, from the base station, a DCI comprising a TAC value in an MCS field of the DCI; and calculating a closed loop component of the second TA value using the TAC value.

In some embodiments, to determine the second TA value according to the second TA mode, the method 700 further includes: receiving, from the base station, a DCI comprising a TA drift rate for a TA drift, a higher order derivative of the TA drift, and an epoch time; and calculating a closed loop component of the second TA value using the TA drift rate, the higher order derivative of the TA drift, and the epoch time.

In some embodiments of the method 700, the determining to implement a power saving mode at the UE is based on a battery level of the UE.

In some embodiments of the method 700, the first request comprises one or more of: an expiration time of a GNSS data validity duration for the first GNSS data; a last GNSS-measured location by the UE; and a desired minimum duration for operating in the second TA mode.

In some embodiments of the method 700, the first reply comprises one or more of: a timing for the transitioning from the first TA mode to the second TA mode; a TAC value; and a maximum duration for operating in the second TA mode.

In some embodiments, the method 700 further includes: identifying, after entering the second TA mode, a successful GNSS data acquisition of second GNSS data at the UE; sending, to the base station, in response to the successful GNSS data acquisition of the second GNSS data, a second request to transition from operating in the second TA mode to operating in the first TA mode according to which the UE determines a third TA value for the UE using the second GNSS data; receiving, from the base station, a second reply indicating that the UE may transition from operating in the second TA mode to operating in the first TA mode; and transitioning, in response to the second reply, from operating in the second TA mode to operating the first TA mode. In some such embodiments, the second request comprises a GNSS data validity duration for the second GNSS data. In some such embodiments, the second reply comprises a timing for the transitioning from the second TA mode to the first TA mode.

In some embodiments of the method 700, the first TA mode is an open and closed loop TA mode.

In some embodiments of the method 700, the second TA mode is a closed loop TA mode.

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications and other 3GPP documents.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as terrestrial base station 812, the terrestrial base station 814 the satellite base station 836 and the satellite base station 838) and/or other entities (e.g., the satellite 842, which may not have base station functionality) that enable the connection 808 and connection 810. One or more satellite gateways 834 may integrate the satellite base station 836, satellite base station 838, and/or the satellite 842 into the RAN 806, in the manners (and with the appropriate elements) described in relation to the NTN architecture 100 of FIG. 1 and the NTN architecture 200 of FIG. 2.

It may be understood that, in alternative embodiments to FIG. 8, the satellite base station 836, the satellite base station 838, and/or the satellite 842 may instead comprise a non-satellite NTN vehicle (e.g., an airplane, a UAV, a UAS, an airship, a balloon, etc.). Further, it may be understood in such alternative embodiments that any satellite gateway 834 may be a gateway for or corresponding to that applicable NTN vehicle type.

In this example, the connection 808 and connection 810 are air interfaces to enable such communicative coupling and may be consistent with RAT(s) used by the RAN 806, such as, for example, an LTE and/or NR. It is contemplated that the connection 808 and connection 810 may include, in some embodiments, service links between their respective UE 802, UE 804 and one or more of the satellite base station 836, the satellite base station 838, and the satellite 842.

In some embodiments, the UE 802 and UE 804 may also directly exchange communication data via a sidelink interface 816.

The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other, with the terrestrial base station 812, the terrestrial base station 814, the satellite base station 836, the satellite base station 838, and/or the satellite 842 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the terrestrial base station 812, terrestrial base station 814, the satellite base station 836 and/or the satellite base station 838 may be implemented as one or more software entities running on server computers as part of a virtual network.

In addition, or in other embodiments, the terrestrial base station 812 or terrestrial base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. It is contemplated than an inter-satellite link (ISL) may carry the X2 interface between in the case of two satellite base stations.

In embodiments where the wireless communication system 800 is an NR system (e.g., when CN 824 is a 5GC), the interface 822 may be an Xn interface. An Xn interface is defined between two or more base stations that connect to 5GC (e.g., CN 824). For example, the Xn interface may be between two or more gNBs that connect to 5GC, a gNB connecting to 5GC and an eNB, between two eNBs connecting to 5GC, and/or two or more satellite base stations via an ISL (as in, e.g., the interface 840 between the satellite base station 836 and the satellite base station 838).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium). For example, the components of the CN 824 may be implemented in one or more processors and/or one or more associated memories.

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the terrestrial base station 812, terrestrial base station 814, the satellite base station 836, or the interface 840 and a serving gateway (S-GW), and the S1-MME interface, which is a signaling interface between the terrestrial base station 812, the terrestrial base station 814 the satellite base station 836, or the interface 840 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the terrestrial base station 812, terrestrial base station 814, satellite base station 836, or satellite base station 838 and a user plane function (UPF), and the S1 control plane (NG-C) interface, which is a signaling interface between the terrestrial base station 812, terrestrial base station 814 satellite base station 836, or satellite base station 838 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VOIP sessions, group communication sessions, etc.) for the UE 802 and UE 804 via the CN 824. The application server 830 may communicate with the CN 824 through an IP communications interface 832.

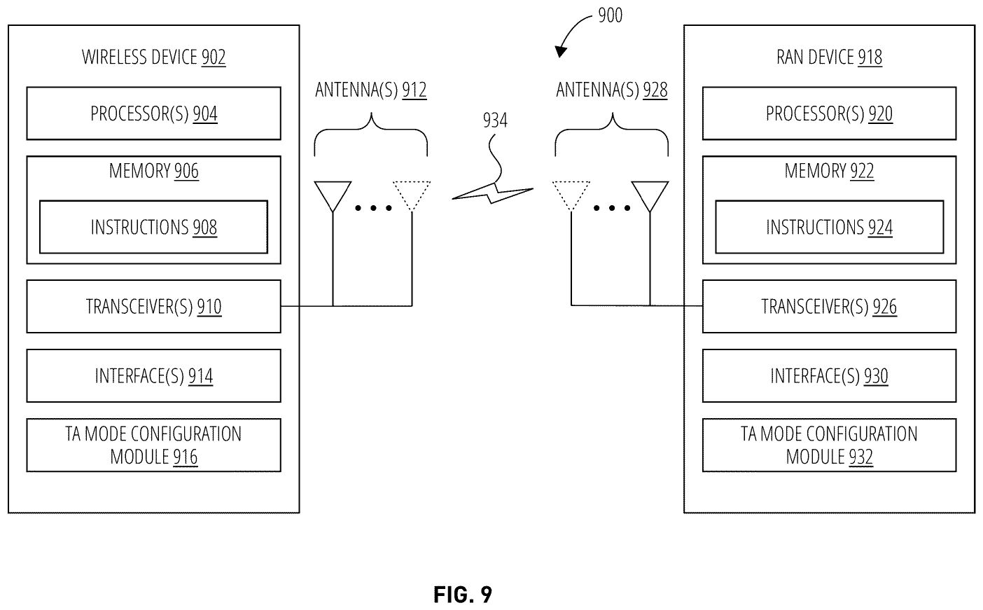

FIG. 9 illustrates a system 900 for performing signaling 934 between a wireless device 902 and a RAN device 918, according to embodiments disclosed herein. The system 900 may be a portion of a wireless communications system as herein described. The wireless device 902 may be, for example, a UE of a wireless communication system. The RAN device 918 may be, for example, a base station (e.g., an eNB or a gNB) of a wireless communication system that is a terrestrial base station or that is a non-terrestrial base station sited on an NTN vehicle. In the case of a RAN device 918 that is a terrestrial base station, the RAN device 918 may be in communication with an NTN vehicle that directly provides radio access connectivity to a UE, in the manner described herein.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 934) to and/or from the wireless device 902 with other devices (e.g., the RAN device 918) according to corresponding RATs. In some embodiments, the antenna(s) 912 may include a moving parabolic antenna, an omni-directional phased-array antenna, or some other antenna suitable for communication with an NTN vehicle, (e.g., as described above in relation to the UE 110 of FIG. 1 and the UE 208 of FIG. 2).

For a RAN device 918 that is a terrestrial base station, the network device signaling 934 may occur on a service link between the wireless device 902 and an NTN vehicle and a feeder link between the NTN vehicle and the RAN device 918 (e.g., as described in relation to FIG. 1). For a RAN device 918 that is a base station sited on an NTN vehicle, the signaling 934 may occur on a service link between the wireless device 902 and the RAN device 918 (e.g., as described in relation to FIG. 2).

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth® and the like).

The wireless device 902 may include a TA mode configuration module 916. The TA mode configuration module 916 may be implemented via hardware, software, or combinations thereof. For example, the TA mode configuration module 916 may be implemented as a processor, circuit, and/or instructions 908 stored in the memory 906 and executed by the processor(s) 904. In some examples, the TA mode configuration module 916 may be integrated within the processor(s) 904 and/or the transceiver(s) 910. For example, the TA mode configuration module 916 may be implemented by a combination of software components (e.g., executed by a DSP or a general processor) and hardware components (e.g., logic gates and circuitry) within the processor(s) 904 or the transceiver(s) 910.

The TA mode configuration module 916 may be used for various aspects of the present disclosure, for example, aspects of FIG. 5 and/or FIG. 7. The TA mode configuration module 916 may configure the wireless device 902 to, for example, send a request to the RAN device 918 to enter a closed loop TA mode, receive a reply from the RAN device 918 indicating that the wireless device 902 may enter the closed loop TA mode, calculate a timing advance value according to the closed loop TA mode (e.g., using information received form the RAN device 918, send a request to the RAN device 918 to enter an open and closed loop TA mode, receive a reply from the RAN device 918 indicating that the wireless device 902 may enter the open and closed loop TA mode, and/or calculate a timing advance value according to the open and closed loop TA mode (e.g., using information received from the RAN device 918, as described herein.

The RAN device 918 may include one or more processor(s) 920. The processor(s) 920 may execute instructions such that various operations of the RAN device 918 are performed, as described herein. The processor(s) 904 may include one or more baseband processors implemented using, for example, a CPU, a DSP, an ASIC, a controller, an FPGA device, another hardware device, a firmware device, or any combination thereof configured to perform the operations described herein.

The RAN device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The RAN device 918 may include one or more transceiver(s) 926 that may include RF transmitter and/or receiver circuitry that use the antenna(s) 928 of the RAN device 918 to facilitate signaling (e.g., the signaling 934) to and/or from the RAN device 918 with other devices (e.g., the wireless device 902) according to corresponding RATs.

The RAN device 918 may include one or more antenna(s) 928 (e.g., one, two, four, or more). In embodiments having multiple antenna(s) 928, the RAN device 918 may perform MIMO, digital beamforming, analog beamforming, beam steering, etc., as has been described.

For a RAN device 918 that is a terrestrial base station, one or more of the transceiver(s) 926 and/or the antenna(s) 928 may instead be present on a satellite gateway (or a gateway for another applicable NTN vehicle type) associated with the base station (e.g., as shown in reference to the terrestrial base station 104 and the satellite gateway 106 of FIG. 1). For a RAN device 918 that is a base station sited on an NTN vehicle, the transceiver(s) 926 and/or the antenna(s) 928 may be present on the NTN vehicle, and one or more of those antenna(s) 928 may be antenna(s) appropriate for non-terrestrial communication (such as a moving parabolic antenna, an omni-directional phased-array antenna, etc.)

The RAN device 918 may include one or more interface(s) 930. The interface(s) 930 may be used to provide input to or output from the RAN device 918. For example, a RAN device 918 that is a base station may include interface(s) 930 made up of transmitters, receivers, and other circuitry (e.g., other than the transceiver(s) 926/antenna(s) 928 already described) that enables the base station to communicate with other equipment in a CN, and/or that enables the base station to communicate with external networks, computers, databases, and the like for purposes of operations, administration, and maintenance of the base station or other equipment operably connected thereto.

The RAN device 918 may include a TA mode configuration module 932. The TA mode configuration module 932 may be implemented via hardware, software, or combinations thereof. For example, the TA mode configuration module 932 may be implemented as a processor, circuit, and/or instructions 924 stored in the memory 922 and executed by the processor(s) 920. In some examples, the TA mode configuration module 932 may be integrated within the processor(s) 920 and/or the transceiver(s) 926. For example, the TA mode configuration module 932 may be implemented by a combination of software components (e.g., executed by a DSP or a general processor) and hardware components (e.g., logic gates and circuitry) within the processor(s) 920 or the transceiver(s) 926.

The TA mode configuration module 932 may be used for various aspects of the present disclosure, for example, aspects of FIG. 6. The TA mode configuration module 932 may configure the RAN device 918 to, for example, receive a request from the wireless device 902 to enter a closed loop TA mode, send a reply to the wireless device 902 indicating that the wireless device 902 may enter the closed loop TA mode, send the wireless device 902 information to enable the wireless device 902 to calculate a timing advance value using the closed loop TA mode, receive a request from the wireless device 902 to enter an open and closed loop TA mode, send a reply to the wireless device 902 indicating that the wireless device 902 may enter the open and closed loop TA mode, and/or send the wireless device 902 information to enable the wireless device 902 to calculate a timing advance value using the open and closed loop TA mode as described herein.

Embodiments contemplated herein include an apparatus comprising means to perform one or more elements of any of the method 500 and/or the method 700. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 500 and/or the method 700. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of any of the method 500 and/or the method 700. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 500 and/or the method 700. This apparatus may be, for example, an apparatus of a UE (such as a wireless device 902 that is a UE, as described herein).

Embodiments contemplated herein include a signal as described in or related to one or more elements of any of the method 500 and/or the method 700.

Embodiments contemplated herein include a computer program or computer program product comprising instructions, wherein execution of the program by a processor is to cause the processor to carry out one or more elements of any of the method 500 and/or the method 700. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

Embodiments contemplated herein include an apparatus comprising means to perform one or more elements of the method 600. This apparatus may be, for example, an apparatus of a base station (such as a RAN device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 922 of a RAN device 918 that is a base station, as described herein).

Embodiments contemplated herein include an apparatus comprising logic, modules, or circuitry to perform one or more elements of the method 600. This apparatus may be, for example, an apparatus of a base station (such as a RAN device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a RAN device 918 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 920of a RAN device 918 that is a base station, as described herein). These instructions may be, for example, located in the processor and/or on a memory of the base station (such as a memory 922 of a RAN device 918 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE) of a non-terrestrial network (NTN), comprising:
identifying a global navigation satellite system (GNSS) data acquisition failure by the UE;
sending, to a base station of the NTN network, in response to the GNSS data acquisition failure, a first request to transition from operating in a first timing advance (TA) mode according to which the UE determines a first TA value for the UE using first GNSS data determined at the UE to operating in a second TA mode according to which the UE determines a second TA value for the UE without using any GNSS data; and
receiving, from the base station, a first reply indicating that the UE may transition from operating in the first TA mode to operating in the second TA mode;
transitioning, in response to the reply, from operating in the first TA mode to operating in the second TA mode;
determining a timing of an uplink (UL) transmission using the second TA value; and
sending the UL transmission to the base station according to the timing.

2. The method of claim 1, wherein to determine the second TA value according to the second TA mode, the method further comprises:
receiving, from the base station, a medium access control control element (MAC-CE) comprising a TA drift rate of a TA drift, a higher order derivative for the TA drift, and an epoch time; and
calculating a closed loop component of the second TA value using the TA drift rate, the higher order derivative of the TA drift, and the epoch time.

3. The method of claim 1, wherein to determine the second TA value according to the second TA mode, the method further comprises:
receiving, from the base station, a medium access control control element (MAC-CE) having a timing advance command (TAC) field of greater than six bits; and
calculating a closed loop component of the second TA value using a TAC value represented in the TAC field.

4. The method of claim 1, wherein to determine the second TA value according to the second TA mode, the method further comprises:
receiving a medium access control control element (MAC-CE) comprising a timing advance command (TAC) value; and
calculating a closed loop component of the second TA value using:
$${N}_{TA - new} = {N}_{TA - old} + ( {T}_{A} - 31 ) * S * 16 * 64 / {2}^{μ} ,$$
where:
N_{TA-new} is the closed loop component of the second TA value;
N_{TA-old} is a prior closed loop component for the first TA value;
T_{A} is the TAC value;
S is a scaling factor; and
μ is a subcarrier spacing (SCS) value corresponding to an SCS used for the UL transmission.

5. The method of claim 1, wherein to determine the second TA value according to the second TA mode, the method further comprises:
receiving, from the base station, a downlink control information (DCI) comprising a timing advance command (TAC) field; and
calculating a closed loop component of the second TA value using a TAC value represented in the TAC field.

6. The method of claim 1, wherein to determine the second TA value according to the second TA mode, the method further comprises:
receiving, from the base station, a downlink control information (DCI) comprising a timing advance command (TAC) value in a modulation and coding scheme (MCS) field of the DCI; and
calculating a closed loop component of the second TA value using the TAC value.

7. The method of claim 1, wherein to determine the second TA value according to the second TA mode, the method further comprises:
receiving, from the base station, a downlink control information (DCI) comprising a TA drift rate for a TA drift, a higher order derivative of the TA drift, and an epoch time; and
calculating a closed loop component of the second TA value using the TA drift rate, the higher order derivative of the TA drift, and the epoch time.

8. The method of claim 1, wherein the GNSS data acquisition failure comprises a loss of a GNSS signal at the UE.

9. The method of claim 1, wherein the GNSS data acquisition failure comprises a determination at the UE that a received GNSS signal does not meet a GNSS signal requirement.

10. The method of claim 1, wherein the first request is sent in further response to a determination that a remaining portion of a GNSS data validity duration for the first GNSS data at the UE does not meet a threshold.

11. The method of claim 10, wherein the threshold depends on one or more of:
a round trip time (RTT) between the UE and the base station;
a distance between the UE and an NTN vehicle for an NTN service link used by the UE to communicate with the base station; and
a timing drift rate at the UE.

12. The method of claim 1, wherein the first request comprises one or more of:
an expiration time of a GNSS data validity duration for the first GNSS data;
a last GNSS-measured location by the UE; and
a desired minimum duration for operating in the second TA mode.

13. The method of claim 1, wherein the first reply comprises one or more of:
a timing for the transitioning from the first TA mode to the second TA mode;
a timing advance command (TAC) value; and
a maximum duration for operating in the second TA mode.

14. The method of claim 1, further comprising:
identifying, after entering the second TA mode, a successful GNSS data acquisition of second GNSS data at the UE;
sending, to the base station, in response to the successful GNSS data acquisition of the second GNSS data, a second request to transition from operating in the second TA mode to operating in the first TA mode according to which the UE determines a third TA value for the UE using the second GNSS data;
receiving, from the base station, a second reply indicating that the UE may transition from operating in the second TA mode to operating in the first TA mode; and
transitioning, in response to the second reply, from operating in the second TA mode to operating the first TA mode.

15. The method of claim 14, wherein the second request comprises a GNSS data validity duration for the second GNSS data.

16. The method of claim 14, wherein the second reply comprises a timing for the transitioning from the second TA mode to the first TA mode.

17. The method of claim 1, wherein the first TA mode is an open and closed loop TA mode.

18. The method of claim 1, wherein the second TA mode is a closed loop TA mode.

19. A method of a base station of a non-terrestrial network (NTN), comprising:
receiving, from a user equipment (UE), a first request to transition from operating in a first timing advance (TA) mode according to which the UE determines a first TA value for the UE using first global navigation satellite system (GNSS) data determined at the UE to operating in a second TA mode according to which the UE determines a second TA value for the UE without using any GNSS data;
sending, to the UE, a first reply indicating that the UE may transition from operating in the first TA mode to operating in the second TA mode; and
receiving an uplink (UL) transmission from the UE after sending the first reply.

20. The method of claim 19, further comprising sending, to the UE, a medium access control control element (MAC-CE) comprising a TA drift rate of a TA drift, a higher order derivative of the TA drift, and an epoch time.
